(19) United States
(12) Patent Application Publication
(10) Pub. No.: US 2014/0189509 A1
(43) Pub. Date: Jul. 3, 2014

(54) PASSIVE INTERACTION GUIDE SYSTEM AND METHOD

(71) Applicant: AVAYA INC., Basking Ridge, NJ (US)

(72) Inventors: Matthew Moran, Galway (IE); Cathy Talbot, Co. Galway (IE); Eoin McDermott, Co. Galway (IE); Paul D'Arcy, Limerick (IE)

(73) Assignee: AVAYA INC., Basking Ridge, NJ (US)

(21) Appl. No.: 13/728,027

(22) Filed: Dec. 27, 2012

(51) Int. Cl. G06F 3/048

(52) U.S. Cl. CPC G06F 3/048
USPC 715/708

(57) ABSTRACT

An interactive communications system includes a passive guide system for guiding users on a website to locate their desired content. The passive guide system includes a monitor module configured to monitor user's interaction with content of the website. The passive guide system further includes an analysis module configured to analyse the user's interaction to anticipate user's requirement. The passive guide system further includes a guide module configured to present a message for guiding the user to locate the content on the website based on the anticipated user's requirement. The passive guide system also includes a feedback module for receiving a feedback from the user and changing the previous message based on the feedback.

### BACKGROUND

1. Field of the Invention

Embodiments of the present invention generally relate to a system and method for passively interacting with website users and particularly to a system and method for passively guiding a user on a website utilizing contact center technology.

2. Description of Related Art

Generally, website-owners seek information browsed/searched by visitors/users on their website. Website owners can utilize the information provided by visitors to their sites to guide those visitors to most relevant content, product or service. For example, the information corresponding to the website visitors can be utilized by the website owners to ease the effort of the website visitors to search for required information, product, or service by providing him/her tailored guidance, suggestions, and information.

Further, the website owners can utilize the information provided by visitors to their sites to anticipate the usage pattern of those visitors. Further, the website owners can utilize the information provided by visitors to their sites to identify, in real time, when a visitor is about to leave the website without carrying out an action of value to the website owner. Website owners can also use the information to attract the visitors for commercial benefits or for promotion. This may help the website owners to retain their regular visitors/customers. Further, this may also help the website owners to increase their website traffic by alluring accidental website visitors.

However, the means to retrieve information browsed by the website visitors are very limited and inefficient. More specifically, the means of gathering information corresponding to the website visitors are limited to cookies and live-chats only. Although the cookies can store implicit information chunks about the visitors that can be very useful for the website owners, the cookies are not very reliable as the cookies can be disabled by the website visitors.

Further, the live-chats, web-chats, or exchange of instant messages between website agents and website visitors is a reliable way of gathering information and anticipating requirements of the website visitors. However, the usage of live-chats requires an explicit and active interaction between the website visitor and an agent of the website, which adds cost to the website owner.

Further, a common issue faced by web surfers is that they encounter a lot of websites having large volumes of information, content and/or multiple service offerings. Generally, for most of the web surfers, it can be difficult to find content or services of interest in such heavily loaded websites. This may lead to potential loss of sales opportunities for the website owners. Additionally, from the perspective of a consumer (i.e., website visitor), visiting such a loaded website and navigating to relevant content or services of interest requires trial-browsing, which can be time-consuming or annoying. Also, if the consumer fails to locate relevant content or services in a short period, or if the only way to achieve relevant information is through initiating interaction with a human agent, the consumer may leave the website. This is not acceptable from a website owner's perspective as this causes potential loss of sale opportunities.

Therefore, there is a need of a system and method that can provide a user friendly and economic approach for helping website visitors in locating their desired content on a website and further alluring the website visitors in order to increase sale opportunities and to increase website traffic.

### SUMMARY

Embodiments in accordance with the present invention provide a passive website guide system and method utilizing contact center technology. The passive guide system includes a monitor module configured to monitor user's interaction with content of a website. The passive guide system further includes an analysis module configured to analyse the user's interaction to anticipate a user's requirement. The passive guide system further includes a guide module configured to present a message for guiding the user to locate the desired content on the website based on the anticipated user's requirement. The passive guide system also includes a feedback module for receiving a feedback from the user.

Embodiments in accordance with the present invention further provide a computer-implemented method for guiding a user on a website for a desired content. The computer-implemented method includes monitoring user's interaction with content of the website, analysing the user's interaction to anticipate user's requirement, and presenting a message for guiding the user to locate the desired content on the website.

Embodiments in accordance with the present invention further provide a contact center including a plurality of work item queues and a passive guide system operable to monitor user's interaction with content of a website, analyse the user's interaction to anticipate user's requirement, and present a message for guiding the user to locate the desired content on the website.

The present invention can provide a number of advantages depending on the particular configuration. First, the present invention provides an adaptive mechanism that uses strategic Avaya Aura® contact center architecture to passively track website interaction (with website visitors) in conjunction with complex process of event pattern matching to serve website visitors with relevant data, information, or service. Avaya Aura® is a core communications platform supporting unified communications and contact center solutions for enterprises. It enables SIP-based session management. Although Avaya Aura® is used in this application, it should understood by one of ordinary skill in the art that any communications platform or for that matter contact center platform that supports unified communications and contact center solutions is contemplated by the present invention and that the Avaya Aura® is used by way of example only and for simplicity of explaining embodiments of the present invention.

Further, the present invention provides a mechanism that quickly guides the website visitors to the most relevant content, product, or service as per their needs. Furthermore, the mechanism proposed by the present invention enables the website servers to anticipate usage patterns of its visitors and provide means to determine (in real time) if a visitor is about to leave the website without indulging in any financial transaction. Again further, the mechanism provided by the present invention helps both of the website owners and website visitors to achieve their objectives simultaneously by working in an adaptive and user friendly environment.

Further, the present invention advantageously understands the interaction of customer without direct agent involvement utilizing current and past interaction pattern matching to increase the potential of a positive customer and business outcome. The present invention enables real time custom rendering of front end exposed to customer as driven by the contact center as a result of interactions prior to any agent involvement, if any.

Further, the present invention provides a right match of an agent (automated agent or human agent) by utilizing a history of interactions of the user with a website, and aggregates those into the context of the contact center. Hence, the present invention provides exactly a right person to talk to you instead of just getting any agent, or anybody that's available to talk to you.

These and other advantages will be apparent from the disclosure of the present invention contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein:

FIG. 1 illustrates an exemplary network environment where various embodiments of the present invention may be implemented;

FIG. 2 is a block diagram depicting a contact center according to an embodiment of the present invention;

FIG. 3 is a block diagram of a passive guide system according to an embodiment of the present invention; and

FIGS. 4A and 4B are collectively depicting an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The present invention will be illustrated below in conjunction with an exemplary communication system, e.g., the Avaya Aura® system. Although well suited for use with, e.g., a system having an ACD or other similar contact processing switch, the present invention is not limited to any particular type of communication system switch or configuration of system elements. Those skilled in the art will recognize the disclosed techniques may be used in any communication application in which it is desirable to provide improved contact processing.

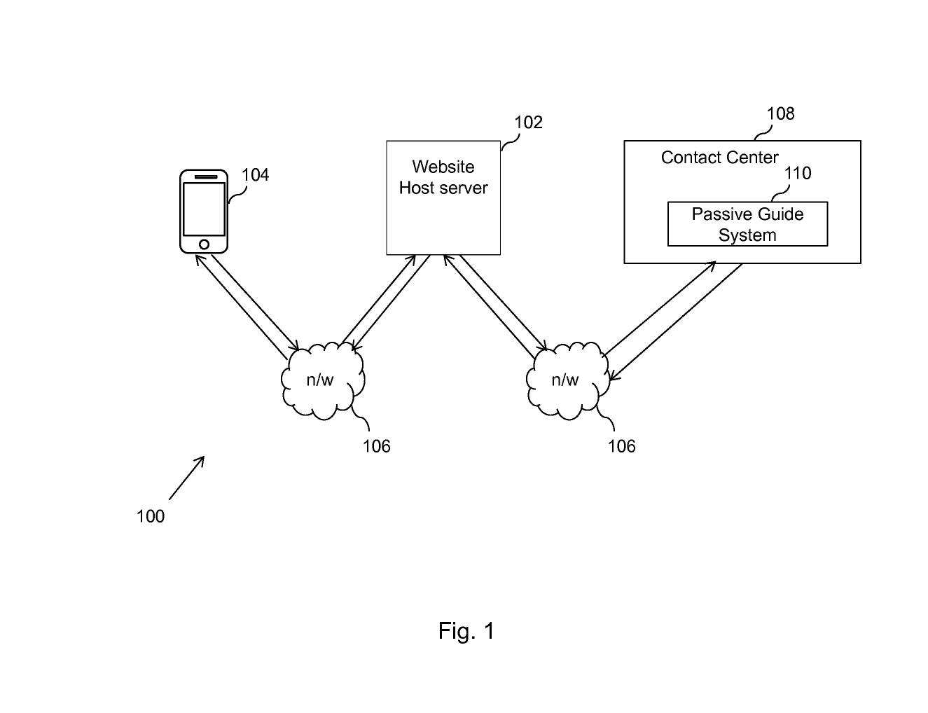

FIG. 1 illustrates an exemplary network environment 100 where various embodiments of the present invention may be implemented. The network environment 100 includes a website host server 102 connected to a user device 104 via a network 106. In an embodiment, the website host server 102 may be connected to a plurality of user devices 104 via the network 106. In another embodiment, a plurality of website host servers 102 may be connected to a plurality of user devices 104 via the network 106. The user devices 104 may refer to electronic devices that may be utilized by users to access the website host server 102 via the network 106. Examples of the user devices 104 may include, but may be not restricted to, a personal computer, a mobile phone, a smart phone, a personal digital assistant (PDA), a tablet computer, a laptop, and the like. The network 106 may include, but is not restricted to, a communication network such as Internet, PSTN, Local Area Network (LAN), Wide Area Network (WAN), Metropolitan Area Network (MAN), and so forth. In an embodiment, the network 106 can be a data network such as the Internet. Further, the messages exchanged between the website host server 102 and the user devices 104 can comprise any suitable message format and protocol capable of communicating the information necessary for the website host server 102 to provide desired information to the user devices 104.

The network environment 100 further includes a contact center 108 connected to the website host server 102 via the network 106. In an embodiment, the network between the contact center 108 and the website host server 102 is same as the network between the user device 104 and the website host server. In another embodiment, the network between the contact center 108 and the website host server 102 may be different from the network between the user device 104 and the website host server 102. The website host server 102 may forward every interaction of a website visitor (or a user) with the website to the contact center 108. The contact center 108 includes a passive guide system 110. The passive guide system 110 may passively guide the user for locating his/her desired content on the website.

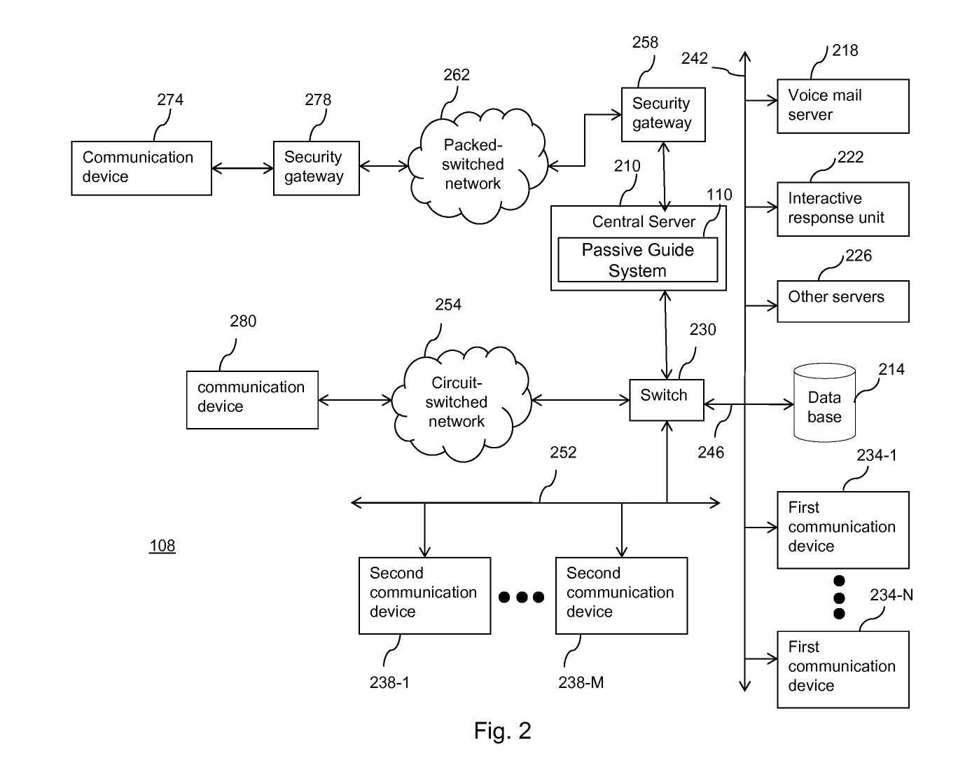

Referring to FIG. 2, an illustrative embodiment of the contact center 108 is shown. The contact center 108 comprises a central server 210, a set of data stores or databases 214 containing contact or customer related information and other information that can enhance the value and efficiency of the contact processing, and a plurality of servers, namely a voice mail server 218, an Interactive Response unit (e.g., IVR) 222, and other servers 226, a switch 230, a plurality of working agents operating packet-switched (first) communication devices 234-1 to N (such as computer work stations or personal computers), and/or circuit-switched (second) communication devices 238-1 to M, all interconnected by a local area network LAN (or wide area network WAN) 242. The servers can be connected via optional communication lines 246 to the switch 230. As will be appreciated, the other servers 226 can also include a scanner (which is normally not connected to the switch 230 or Web server), VoIP software, video call software, voice messaging software, an IP voice server, a fax server, a web server, an email server, and the like. The switch 230 is connected via a plurality of trunks 250 to the Public Switch Telephone Network or PSTN 254 and via link(s) 252 to the second communication devices 238-1 to M. A gateway 258 is positioned between the server 210 and the packet-switched network 262 to process communications passing between the server 210 and the network 262.

Although the preferred embodiment of the present invention is discussed with reference to a client-server architecture, it is to be understood that the principles of the present invention apply to other network architectures. For example, the present invention applies to peer-to-peer networks, such as those envisioned by the Session Initiation Protocol. In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, the present invention does not require the presence of packet- or circuit-switched networks.

In an embodiment, the central server 210 may communicate with a plurality of customer communication lines (which can be one or more trunks, phone lines, etc.) and agent communication line (which can be a voice-and-data transmission line such as LAN 242 and/or a circuit switched voice line). The central server 210 can include a operational contact center reporting module (not shown), such as Avaya IQ™, CMS™, Basic Call Management System™, Operational Analyst™, and Customer Call Routing or CCR™ by Avaya, Inc., gathers call records and contact-center statistics for use in generating contact-center reports.

The switch 230 and/or server 210 can be any architecture for directing contacts to one or more communication devices. In some embodiments of the present invention, the switch 230 may perform load-balancing functions by allocating incoming or outgoing contacts among a plurality of logically and/or geographically distinct contact centers. Illustratively, the switch and/or server can be a modified form of the subscriber-premises equipment sold by Avaya Inc. under the names Definity™ Private-Branch Exchange (PBX)-based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company. Typically, the switch/server is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide automatic contact-distribution functionality. Other types of known switches and servers are well known in the art and therefore not described in detail herein.

Included among the control programs in the server 210 is a work assignment process (not shown in Fig.). Contacts incoming to the contact center are assigned by the work assignment process to different contact queues based upon a number of predetermined criteria, including customer identity, customer needs, contact center needs, current contact center queue lengths, customer value, and the agent skill that is required for the proper handling of the contact. Agents who are available for handling contacts are assigned to agent queues based upon the skills that they possess. An agent may have multiple skills, and hence may be assigned to multiple agent queues simultaneously. Furthermore, an agent may have different levels of skill expertise (e.g., skill levels 1-N in one configuration or merely primary skill levels and secondary skill levels in another configuration), and hence may be assigned to different agent queues at different expertise levels. Further, in an embodiment, the agent is a human agent. In another embodiment, the agent may be an automated agent, as provided by the present invention.

In one configuration, the contact center 108 is operated by a contract operator, and each of the contact queues, and possibly each of the agent queues, corresponds to a different client. Each client can have a separate service level agreement or other type of performance measurement agreement with the contract operator regarding performance expectations, goals, requirements or specifications for the client's respective queue(s).

Further, the gateway 258 can be Avaya Inc.'s, G700 Media Gateway™ and may be implemented as hardware such as via an adjunct processor (as shown) or as a chip in the server.

The first communication devices 234-1, . . . 234-N are packet-switched and can include, for example, IP hard phones such as the Avaya Inc.'s, 4600 Series IP Phones™, IP soft phones such as Avaya Inc.'s, IP Soft Phone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

The second communication devices 238-1, . . . 238-M are circuit-switched. Each of the communication devices 238-1, . . . 238-M corresponds to one of a set of internal extensions Ext1, . . . ExtM, respectively. The second communication devices can include, for example, wired and wireless telephones, PDAs, H.320 videophones and conferencing units, voice messaging and response units, traditional computer telephony adjuncts, and any other communication device.

It should be noted that the present invention does not require any particular type of information transport medium between switch or server and first and second communication devices, i.e., the present invention may be implemented with any desired type of transport medium as well as combinations of different types of transport channels. The packet-switched network 262 can be any data and/or distributed processing network, such as the Internet. The network 262 typically includes proxies (not shown), registrars (not shown), and routers (not shown) for managing packet flows.

The packet-switched network 262 is in communication with a first communication device 274 via a gateway 278, and the circuit-switched network 254 with an external second communication device 280.

In a preferred configuration, the server 210, network 262, and first communication devices 234 are Session Initiation Protocol or SIP compatible and can include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be emphasized that the configuration of the switch, server, user communication devices, and other elements as shown in FIG. 1 is for purposes of illustration only and should not be construed as limiting the present invention to any particular arrangement of elements.

As will be appreciated, the central server 210 is notified via LAN 242 of an incoming contact by a communications component (e.g., switch 230, fax server, email server, web server, and/or other server) receiving an incoming contact. The incoming contact is held by the receiving communications component until the modules forwards instructions to the receiving communications component to forward or route the contact to a specific contact center resource, such as the interactive response unit 222, the voice mail server 218, and/or first or second communication device 234, 238 associated with a selected agent. The central server 210 provides interaction to the contacts, distributes and connects these contacts to communication devices of available agents based on the predetermined criteria noted above.

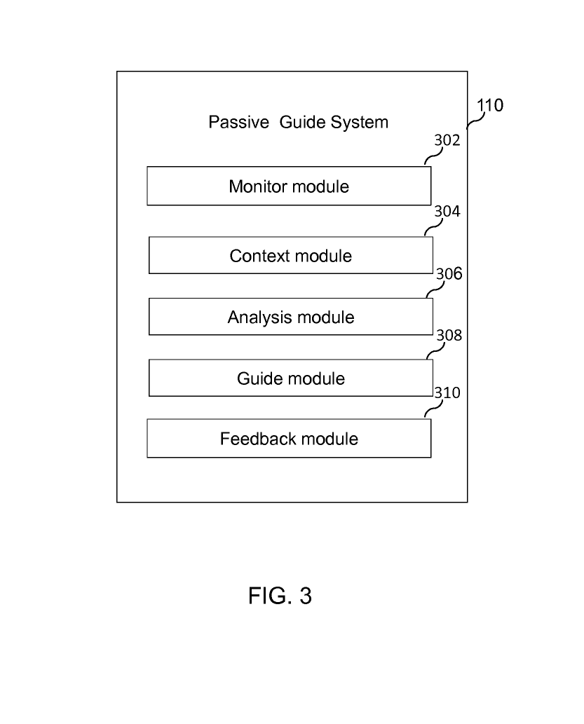

According to an embodiment of the present invention, the central server 210 includes the passive guide system 110. The passive guide system 110 includes a monitor module 302, a context module 304, an analysis module 306, a guide module 308, and a feedback module 310 as shown in FIG. 3. The modules are stored either in the main memory or in a peripheral memory (e.g., disk, CD ROM, etc.) or some other computer-readable medium of the contact center 108.

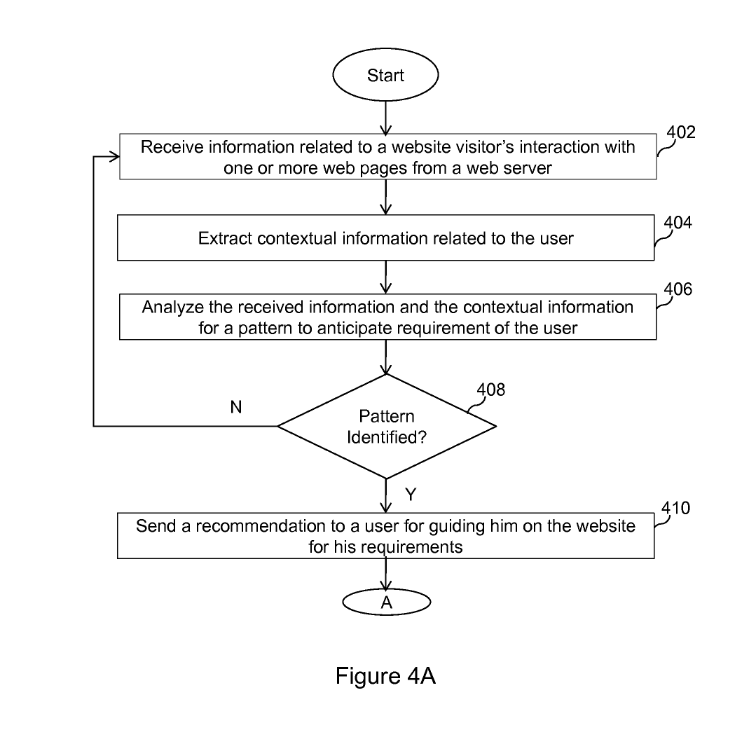

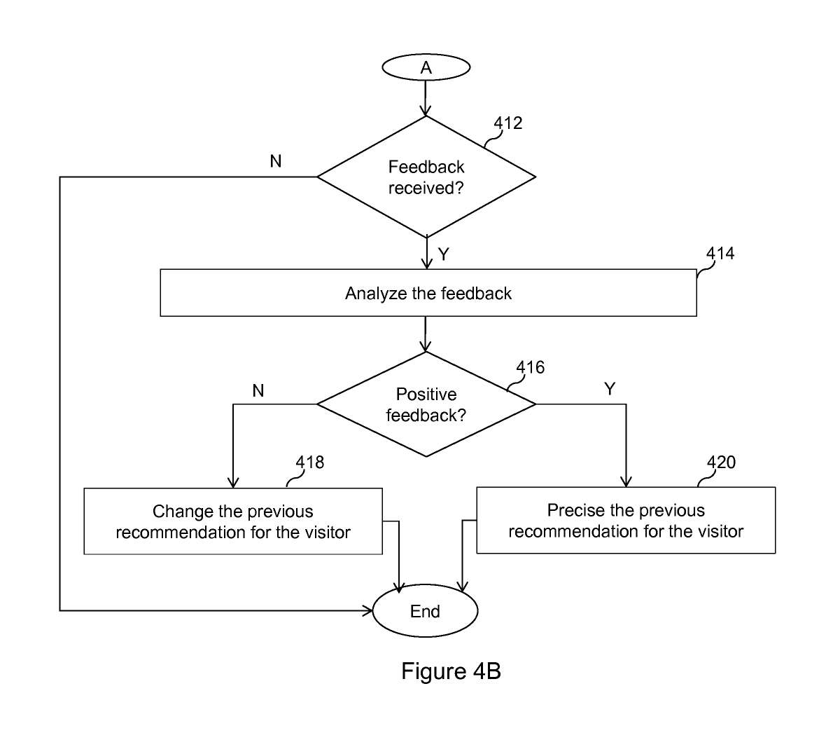

The operation of the monitor module 302, the context module 304, the analysis module 306, the guide module 308, and the feedback module 310 will now be discussed with reference to FIGS. 4A and 4B.

In step 402, the monitor module 302 monitors user's interaction with content of the website. In an embodiment, the monitor module 302 may receive information related to a website visitor's interaction and/or actions with one or more web pages of the website from a website host server 102. Each interaction between the website visitor and website is fed to the monitor module 302 of the contact center 108 in real time or near real time by the web site host server 102. Every interaction with the website is construed as a point of contact of an individual user. Each unit of interaction is treated as a type of contact.

In an embodiment, each click of a mouse may be treated as type of contact. Further, a series of mouse clicks are also treated as a type of contact. Furthermore, a keyboard entry in the user interface of the website is also treated as type of contact. Further, activity and actions of the users are monitored. For example, a series of mouse movements are also treated as a type of contact. Information related to all these types of contacts may be forwarded to the monitor module 302 by the website host server 102. In one embodiment, click stream technology may be used to harvest the user's interactions with the website in real time.

Further, each individual unit of types of contacts may be individually tracked, and stored in the database 214. Further, the contact center 108 stores information related to communications originated from a customer that calls (or previously called) into the contact center in the database 214. The contact center 108 further makes a list of work items or work requests that includes contact phones and contacts. Further, the contact center 108 may connect a customer to a suitable agent at the contact center. For requests related to the contacts, coming from the visitors of some websites, the contact center 108, in form of an automated agent, may guide the visitors of the website to find a desired or relevant content on the website.

In an embodiment, the information related to the various contacts and interactions between the website visitor and the website is equivalent to the website visitor being on a phone to the contact center 108, navigating around the website, telling the contact center 108 exactly everything he clicks, including rolling mouse over a certain image. Those skilled in the art will appreciate that it is sufficient information in a contact center environment, along with all of the contextual data that comes with the clicks, along with existing customer information that the contact center 108 includes in the database 214.

In step 404, the context module 304 extracts contextual information related to the user (e.g., website visitor). In an embodiment, the contextual information includes IP address based location information of the user. In another embodiment, the contextual information may include history of user's previous interactions on the same website. In yet another embodiment, the contextual information may further include a history of a user's previous interactions/calls in the contact center. The contextual information thus retrieved may help and/or identify the user and the user's current requirements based on previous inquiries or previous requirements.

In step 406, the analysis module 306 analyzes the received information and the contextual information. In one embodiment, the analysis module 306 analyzes the received information and the contextual information for a pattern to anticipate a current requirement of the user. The analysis module 306 may utilize a complex event processing (CEP) engine (not shown in figure) to determine a pattern associated with the user's interactions with the website.

At step 408, it is determined by the analysis module 306 whether a pattern has been identified. The analysis module 306 may match the pattern of activity of the user (e.g., customer) taken at the web page of the web site with any previously stored pattern for a specific requirement in the database 214. The analysis module 306 further makes a decision about how the user can be guided through the website to locate his/her desired content.

At step 410, the guide module 308 passively sends a recommendation or message to the user for guiding him on the website for his/her desired content or content according to his/her current requirements. The recommendation may be dynamically sent or rendered on a user interface based on the user (e.g. customer) past interactions and the current trend of his/her engagement. For example, the recommendation may be sent via a pop-up message. In an embodiment, the recommendation is based on the real time pattern of contacts created in the context (i.e. the identified pattern) and the real time contextual data. Further, the guide module 308 may auto-update the recommendation sent to the user based on interaction with Avaya Aura® contact center without explicitly informing the user about it. For example, based on user's previous interactions with the contact center and/or same website (i.e. the contextual information), the guide module 308 may dynamically update the recommendation sent to the user so that the user may easily reach a desired/targeted piece of content on the website. Furthermore, information supplied to the website by the consumer (for example, cookies) may also be utilized in the recommendation.

The recommendation/message may be provided on the user interface of the website so the user may read it for his guide. The user (or consumer) is automatically and passively (no human agent) guided to content or services considered most relevant based on context built up from their current interaction and any previous interactions with the website.

At step 412, it is determined by the feedback module 310 whether feedback has been received. The user may read the recommendation or message, and provide his/her feedback. At step 414, feedback module 310 receives and analyses the feedback.

At step 416, it is determined by the feedback module 310 whether the feedback is positive feedback or negative feedback. In an embodiment, the recommendation may be not be helpful to the user. For example, the user may want to search or look for some other thing than proposed by the recommendation. In those cases, the user may reject the recommendation and the rejection message may be received by the passive guide system 110 as a negative feedback. In case of the negative feedback, at step 418, the feedback module 310 dynamically and passively changes the previous recommendation for the user.

In another embodiment, the user may read the recommendation and may not respond to the recommendation as he finds it not helpful or he may not want to use that. The passive guide system waits for a predetermined time (for example, 1 minute) and then changes the recommendation/message sent to the user. Those skilled in the art will appreciate that it may possible that this time, the recommendation might prove to be helpful for the user and he might respond to it for a positive or negative feedback.

In another embodiment, the recommendation/message may be helpful for the user. For example, the user may want to search or look for same thing that is proposed by the recommendation. In those cases, the user may accept the recommendation and that may be received by the passive guide system 110 as a positive feedback. In case of the positive feedback, at step 420, the feedback module 310 passively and dynamically precises the previous recommendation/message for the user. In an embodiment, the feedback module 310 may narrow down a category of products that the user is looking for. The feedback module 310 may present this recommendation as well to the user and wait for his feedback. Hence, the user may be passively guided till he reaches his/her desired content on the website in a quick time.

Hence, the present invention utilizes the customer's pattern of interaction for making decisions on how to provide content for the web pages, or to adjust how the navigation pattern of the web page; or even to decide, at a certain point, to make a decision that the customer interacting with the website would believe, and helped by possibly a message window opening up on the web page, to say, “Hey, welcome to our website. We see you are doing X and Y, and can we help you? We think this is what you're looking for . . . .”, thereby improving the overall customer experience.

An example will now be discussed to illustrate the above principles.

### Example 1

A customer is trying to figure out a suitable TV for his room. The customer goes under the electronics section on website of a TV brand, then in the TV section, and then at the Sharp Aquos. The present invention may monitor it and provide a recommendation in form of the following pop-up message to screen of the website for the user “Hey, we saw you go deep into five levels, and you're now at this TV. You know, you went under electronics, TVs, LCDs, you're now at a Sharp Aquos, and you're trying to figure out what size is best for your room, because your living room couch is 15 feet away from the TV. Can I help you decide whether you want a 50-inch or an 80-inch TV?” The customer will feel very elated to read this and will immediately click on it and will be directly/subsequently taken to that page/information of the website. The popup message may be the outcome of a human or automated agent, in that a contact (as a pattern of interactions) has been routed by the AACC to the human/automated agent, and the popup is the resultant response.

The exemplary systems and methods of this present invention have been described in relation to a contact center. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A passive guide system for guiding users on a website to locate a desired content, comprising:
a monitor module configured to monitor user's interaction with content of the website;
an analysis module configured to analyse the user's interaction to anticipate user's requirement; and
a guide module configured to passively present a message for guiding the user to locate the desired content on the website based on the anticipated user's requirement.

2. The passive guide system of claim 1, wherein the user's interactions comprises a click of mouse, a series of mouse clicks, and a keyboard entry.

3. The passive guide system of claim 1, the monitor module further monitoring user's actions and activities on web pages of the website.

4. The passive guide system of claim 3, wherein the monitor module monitoring a series of mouse movements done by the user on the web pages of the website.

5. The passive guide system of claim 1, further comprising a context module configured to extract contextual information related to the user.

6. The passive guide system of claim 5, wherein the contextual information comprises IP address based location information of the user, and history of the user's previous interactions with a contact center.

7. The passive guide system of claim 6, wherein the guide module dynamically updating the message sent to the user based on the contextual information.

8. The passive guide system of claim 1, wherein analysis module is configured to match a pattern of activity of the user with previously stored patterns.

9. The passive guide system of claim 1, wherein the message comprises a pop-up message on screen of a user device of the user.

10. The passive guide system of claim 1, further comprising a feedback module for receiving a feedback from the user.

11. The passive guide system of claim 10, wherein the feedback module changing the previous message for the user in case of a negative feedback.

12. The passive guide system of claim 10, wherein the feedback module precising the previous message for the user in case of a positive feedback.

13. The passive guide system of claim 1, wherein the guide module is configured to passively guide the user until the user reaches his desired content on the website.

14. A computer-implemented method for guiding a user on a website for a desired content, the method comprising:
monitoring user's interaction with content of the website;
analysing the user's interaction to anticipate user's requirement; and
presenting a message for guiding the user to locate the desired content on the website based on the anticipated user's requirement.

15. The computer-implemented method of claim 14, further comprising extracting contextual information related to the user.

16. The computer-implemented method of claim 1, wherein the analysing comprises matching a pattern of activity of the user with previously stored patterns.

17. The computer-implemented method of claim 1, further comprising receiving a feedback from the user.

18. The computer-implemented method of claim 17, further comprising changing a previous recommendation for the user in case of a negative feedback.

19. The computer-implemented method of claim 4, further comprising precising a previous recommendation for the user in case of a positive feedback.

20. A contact center, comprising:
a plurality of work item queues; and
a passive guide system operable to:
monitor user's interaction with content of the website;
analyse the user's interaction to anticipate user's requirement; and
present a message for guiding the user to locate the content on the website based on the anticipated user's requirement.
